(19) United States
(12) Patent Application Publication
(10) Pub. No.: US 2018/0017675 A1
(43) Pub. Date: Jan. 18, 2018

(54) System for Video-Doppler-Radar Traffic Surveillance

(71) Applicants: Lang Hong, Beavercreek, OH (US); Steven Hong, Beavercreek, OH (US)

(72) Inventors: Lang Hong, Beavercreek, OH (US); Steven Hong, Beavercreek, OH (US)

(21) Appl. No.: 15/209,470

(22) Filed: Jul. 13, 2016

(51) Int. Cl. G01S 13/86; G01S 13/58

(52) U.S. Cl. CPC G01S 13/867; G01S 13/585

(57) ABSTRACT

This invention is related to a Video-Doppler-Radar Traffic Surveillance System comprising of multiple Doppler radars and video cameras, circuitry for processing radar and video signals, and data recording devices. Although the system is mainly designed for roadside traffic surveillance, it can be used in different applications, such as mounted on a host vehicle or on a UAV. The system will provide continuous surveillance of all incoming and leaving traffic.

### TECHNICAL FIELD

The invention relates to a video-Doppler-radar traffic surveillance system.

### BACKGROUND OF THE INVENTION

(1) Doppler Radar Based Traffic Surveillance Systems:

A traditional radar based traffic surveillance system uses a Doppler radar for vehicle speed monitoring which measures a vehicle speed at line-of-sight (LOS). In FIG. 1, the speed of an approaching (or a leaving) vehicle is calculated in terms of Doppler frequency f_{D} by

$${v}_{t} = \frac{{f}_{D}}{K cos ( {φ}_{t} )} \qquad ( 1 )$$

where K is a Doppler frequency conversion constant. Although a Doppler radar based system has an advantage of a long detection range, there are several difficulties associated with the traditional radar based system, including (1) the Doppler radar beam angle is too large to precisely locate vehicles within the radar beam; (2) the angle between the vehicle moving direction and the LOS, φₜ, is unknown and therefore, needs to be small enough for a reasonable speed estimation accuracy; (3) since all velocity vectors on the equal-Doppler cone in FIG. 1 will generate a same speed, the Doppler radar cannot differentiate the vehicles with a same speed but different directions defined by the same equal-Doppler cone. Therefore, no precise target location information can be derived in a traditional Doppler radar based traffic surveillance system.

(2) Video Camera Based Traffic Surveillance Systems:

A video camera based traffic surveillance system uses a video camera to capture a traffic scene and relies on computer vision techniques to indirectly calculate vehicle speeds. Precise vehicle locations can be identified. However, since no direct speed measurements are available and the camera has a finite number of pixels, the video camera based traffic surveillance system can be used only in a short distance application.

### SUMMARY

This invention combines the both a Doppler radar based system and the video based system into a traffic surveillance system to preserve the advantages of both systems and overcome the shortcomings of both systems.

A video-Doppler-radar traffic surveillance system to monitor traffic may include a first movable Doppler radar moving along a first radar motion ray to measure a relative speed of a moving vehicle with respect to the first movable Doppler radar, a second movable Doppler radar moving along a second radar motion ray to measure a relative speed of the moving vehicle with respect to the second movable Doppler radar, a stationary Doppler radar to measure an absolute speed of the moving vehicle with respect to the stationary Doppler radar, a stationary video camera to measure the location of the moving vehicle on its image plane which is intersected by the first and second radar motion rays, a data processing device to process Doppler radar and video information, and a recording device to continuously record the complete information of the moving vehicle.

The surveillance system may register the first movable radar and the second movable radar with the video camera by locating the intersections of the first and second movable radar motion rays with the video camera image plane.

The surveillance system may calculate the radar-based angle of a moving vehicle from two movable Doppler Radars.

The surveillance system may calculate the video-based angle of a moving vehicle on its image plane.

The surveillance system may register the angle of a moving vehicle on its image plane to the angle of a moving vehicle from two movable Doppler radars and register the absolute speed of the moving vehicle to the image plane location.

The surveillance system may record the moving vehicle information onto a data recording device.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates the speed measurement of an approaching vehicle and a leaving vehicle with a Doppler radar;

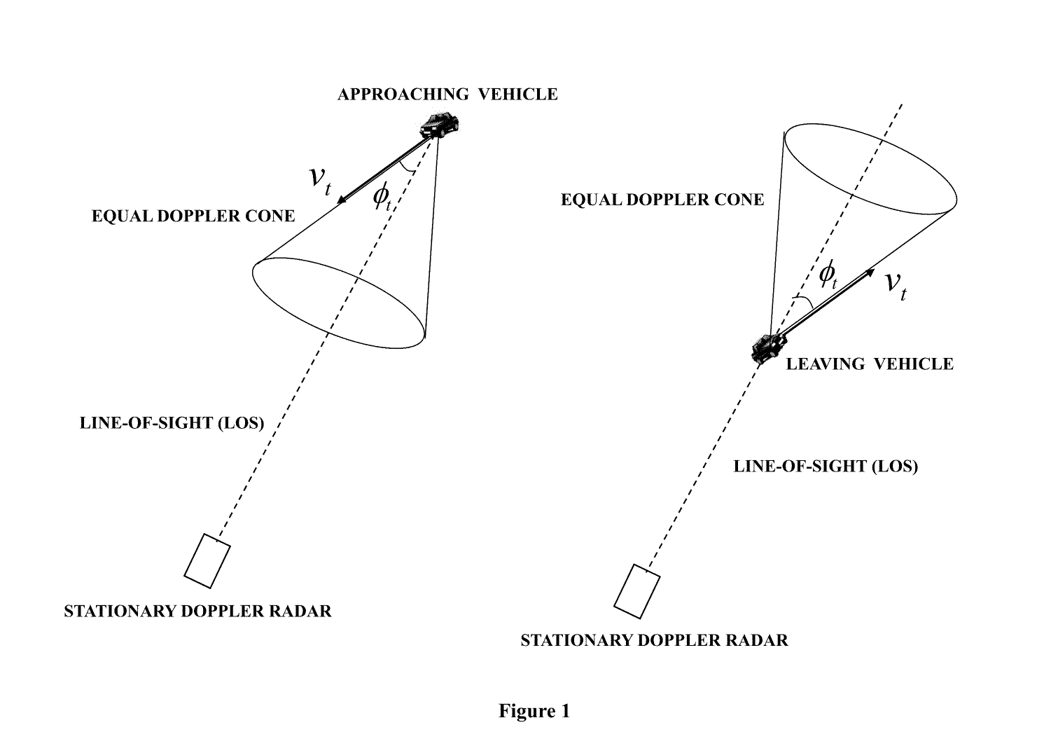

FIG. 2 illustrates the operational setup of the surveillance system;

FIG. 3 illustrates the lay out of the surveillance system;

FIG. 4 illustrates the geometry for radar-based information processing; and

FIG. 5 illustrates the geometry for video-based information processing.

### DETAILED DESCRIPTION

While the term “traffic surveillance” is used herein, it may also refer to other traffic applications, such as “traffic monitoring”, etc. The term “video camera” may refer to “any image device” which may generate any electro-optical or thermal or hyper-spectral images. The term “video” may refer to single or multiple images taken over time. The invention discussed here may be applied to the cases of multiple video cameras and more than three radars.

1. System Setup Description

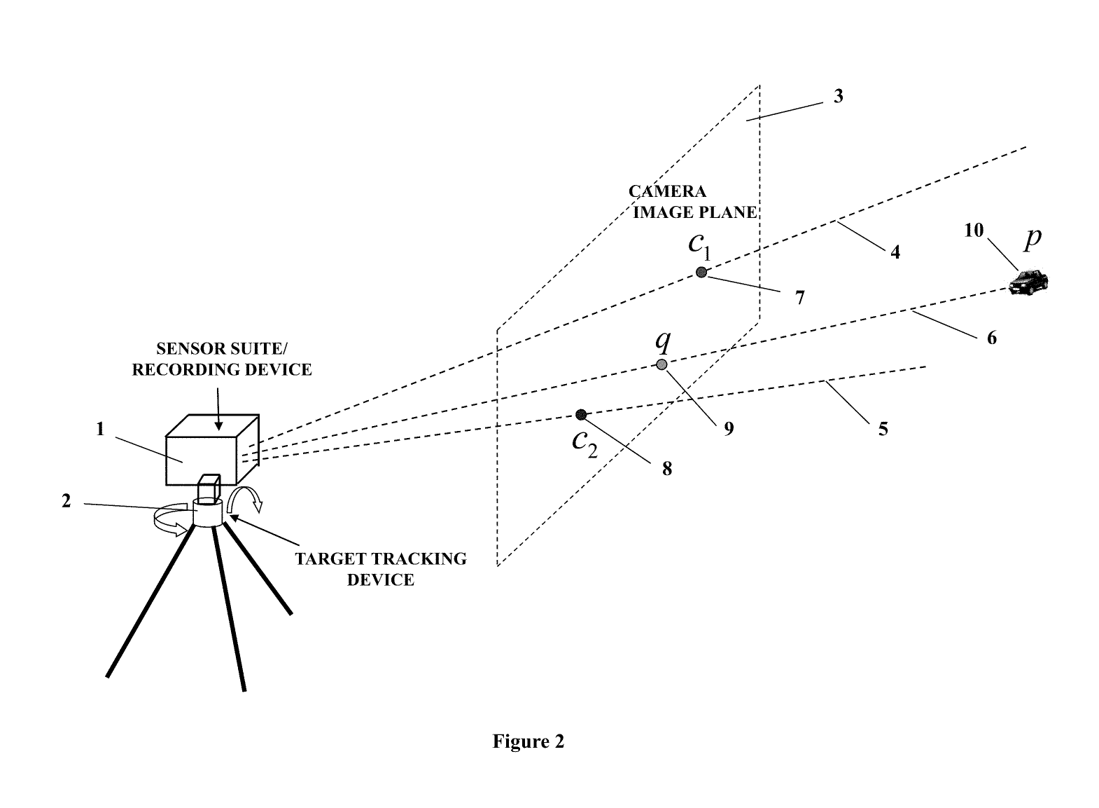

A video-Doppler-radar traffic surveillance system is shown in FIG. 2 where 1—the sensor system which may include a sensor suite/recording device or apparatus, 2—a tracking device, 3—the camera image plane of the video camera 14, 4—a first movable Doppler radar motion ray, 5—a second movable Doppler radar motion ray, 6—a radar direction ray connecting the sensor apparatus 1 to a moving vehicle 10, 7—the intersection of the first Doppler radar motion ray 4 with image plane 3, 8—the intersection of the second Doppler radar motion ray 5 with image plane 3, 9—the intersection of direction ray 6 with image plane 3, and 10 a moving vehicle.

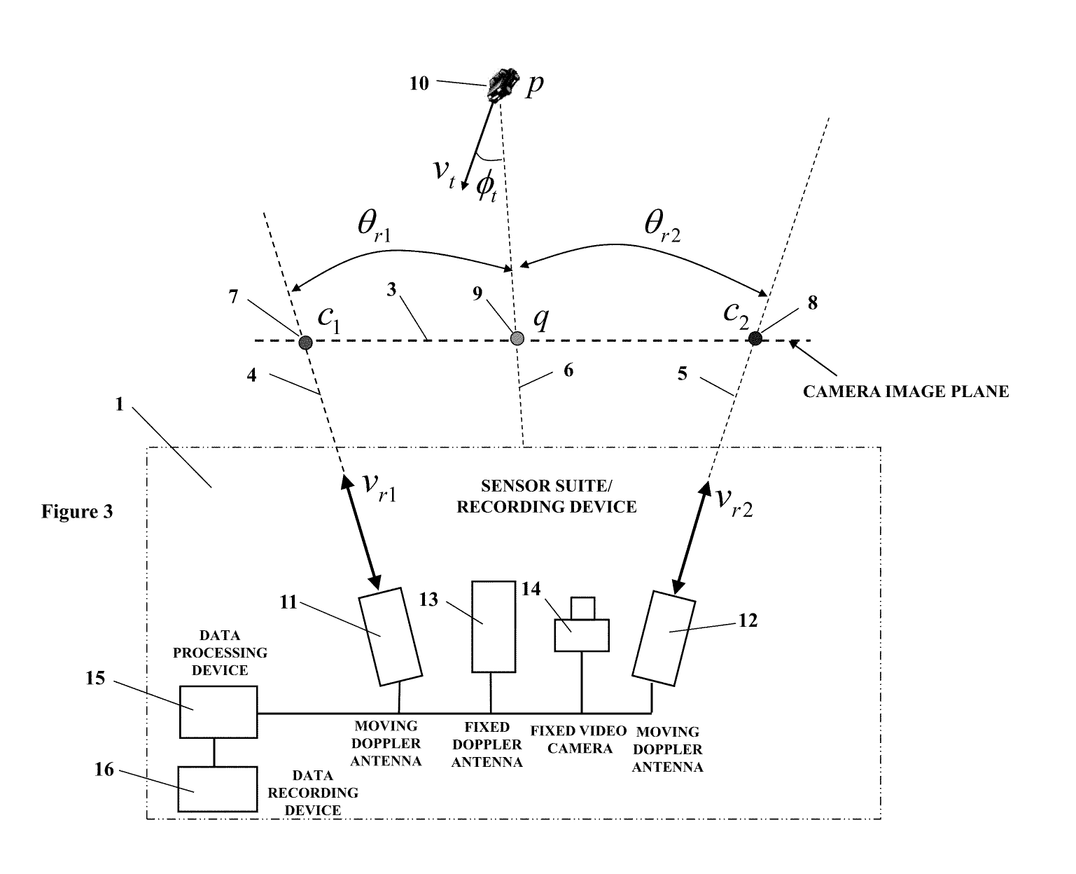

FIG. 3 shows the layout of the sensor apparatus 1 where 11—a first movable Doppler 11 radar adapted to move along first radar motion ray 4 and to measure a relative radial speed of a vehicle 10 on a road way with respect to the first movable Doppler radar 11, 12—a second movable Doppler radar 12 adapted to move along second radar motion ray 5 and to measure a relative radial speed of the vehicle 10 with respect to the second movable Doppler radar 12, 13—a fixed or stationary Doppler radar 13 adapted to orientate along direction ray 6 and to measure an absolute radial speed of the vehicle with respect to the stationary Doppler radar 13, 14—a fixed or stationary video camera 14 adapted to measure the location of the vehicle 10 on its image plane, 15—a data processing device 15, such as a computer, laptop, personal computer, PDA or other such device, which may comprise a plurality of estimators for Doppler and video signal processing, and 16—data recording device 16, such as a hard drive, a flash drive or other such device.

2. Doppler Signals from Doppler Radars

The first and second movable Doppler radars 11, 12 may provide the relative Doppler signals of a moving vehicle on a roadway with respect to the first and second movable Doppler radars (11 and 12 in FIG. 3) as

f_{D}¹=K₁[vₜ cos(φₜ)+vᵣ_{₁} cos(θᵣ₁)] (2)

and

f_{D}²=K₂[vₜ cos(φₜ)+vᵣ_{₂} cos(θᵣ₂)] (3)

where vᵣ_{₁} and vᵣ_{₂} are the motion speeds of the first and second movable Doppler radars 11, 12, θᵣ_{₁} and θᵣ_{₂} are the motion ray orientation angles with respect to the direction ray 6 connecting the sensor apparatus and the moving vehicle 10, vₜ is the speed of the moving vehicle 10, φₜ is the angle of the vehicle motion direction, and K₁ and K₂ are Doppler conversion constants for the first and second moving Doppler radars 11, 12.

The stationary Doppler radar 13 may provide the absolute Doppler signal of the moving vehicle 10 via

f_{D}³=K₃vₜ cos(φₜ) (4)

where K₃ is the Doppler conversion constant for the stationary Doppler radar (13 in FIG. 3).

3. Vehicle Speeds from Doppler Signals

The estimators for Doppler signal processing in the Data processing Unit (15 in FIG. 3) may calculate the relative radial speeds of the moving vehicle 10 with respect to the movable Doppler radars 11,12 as

$$\begin{matrix}{v}_{rt}^{1} = \frac{{f}_{D}^{1}}{{K}_{1}} = {v}_{t} cos ( {φ}_{t} ) + {v}_{{r}_{1}} cos ( {θ}_{r 1} ) \\ and & ( 5 ) \\ {v}_{rt}^{2} = \frac{{f}_{D}^{2}}{{K}_{2}} {v}_{t} cos ( {φ}_{t} ) + {v}_{{r}_{2}} cos ( {θ}_{r 2} ) & ( 6 )\end{matrix}$$

and may calculate the absolute radial speed of the moving vehicle 10 with respect to the stationary Doppler radar 13 as

$${v}_{t}^{3} = \frac{{f}_{D}^{3}}{{K}_{3}} = {v}_{t} cos ( {φ}_{t} ) . \qquad ( 7 )$$

4. Radar-Based Angle Calculation

The estimators for Doppler signal processing may calculate the differences of the relative speeds and the absolution speed

vₜ¹³=vₙ¹−vₜ³=vᵣ₁ cos(θᵣ₁) (8)

and

vₜ²³=vₙ²−vₜ³=vᵣ₁ cos(θᵣ₂) (9)

and may calculate the ratio of the speed differences

$$\frac{{v}_{t}^{13}}{{v}_{t}^{23}} = \frac{{v}_{r 1} cos ( {θ}_{r 1} )}{{v}_{r 2} cos ( {θ}_{r 2} )} . \qquad ( 10 )$$

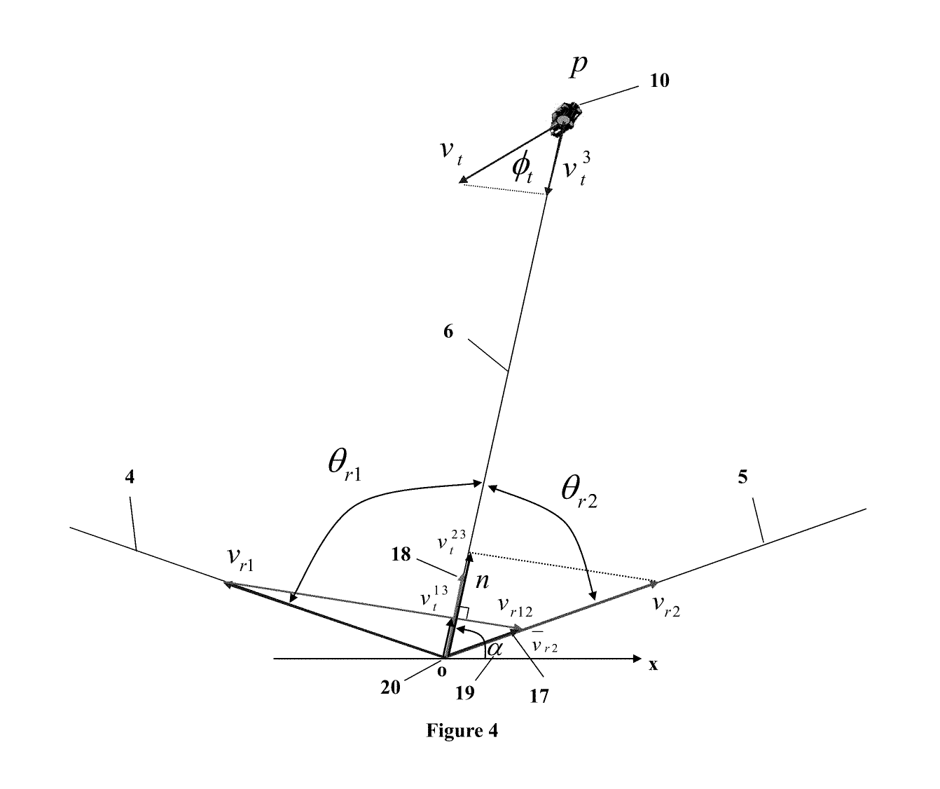

The scaled speed vector 17 along the movable Doppler radar motion ray (either 4 or 5 in FIG. 4) may be calculated as (17 in FIG. 4)

$${\overline{v}}_{r 2} = \frac{{v}_{t}^{13}}{{v}_{t}^{23} } {v}_{r 2} \qquad ( 11 )$$

and a unit vector, n (18 in FIG. 4), along the stationary radar direction ray (6 in FIG. 4) may be calculated by finding the perpendicular vector to v̅ᵣ₂, i.e., n⊥v̅ᵣ₂. The radar-based angle, α (19 in FIG. 4), may be then calculated from the angle of unit vector n.

5. Video-based Angle Calculation

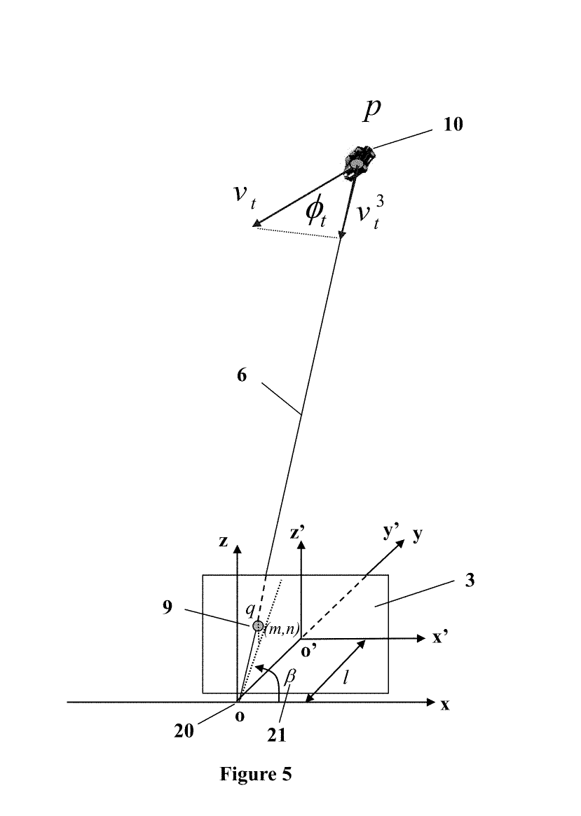

A camera imaging geometry is shown in FIG. 5 where the camera coordinate and radar coordinate in FIG. 4 (only x axis is shown) are registered with the same origin (20 in FIGS. 4 and 5) via calibration. The camera image plane (3 in FIGS. 2, 3 and 5) is parallel to x-z plane with a distance of l. The radar direction ray connecting origin o 20 to the moving vehicle 10, p (6 in FIGS. 2, 3, 4 and 5), intersects with the image plane at q (9 in FIGS. 2, 3 and 5) whose coordinate on the image plane is (m,n). The video-based angle (horizontal angle), β (21 in FIG. 5), may be calculated by

$$β = {tan}^{- 1} ( \frac{l}{m} ) . \qquad ( 12 )$$

6. Registering Moving Vehicle Speed to Image Plane

A moving vehicle 10 with a radar-based angle α 19 and a moving vehicle 10 with a video-based angle β 21 may be considered to be a same vehicle if

|α−β|<γ (13)

where γ is a pre-defined threshold. The absolute radial speed of the moving vehicle 10 vₜ³ calculated in Eq. (7) is then registered to the vehicle's image location on the image plane (9 in FIG. 5).

The vehicle's location and the registered speed may be then recorded in the data recording device (16 in FIG. 3).

1. A system of estimating a moving vehicle velocity, comprising:
a. a first movable Doppler radar adapted to move along a first radar motion ray and to measure a first relative radial speed of a vehicle on a roadway with respect to said first movable Doppler radar;
b. a second movable Doppler radar adapted to move along a second radar motion ray and to measure a second relative radial speed of said vehicle on said roadway with respect to said second movable Doppler radar;
c. a stationary Doppler radar adapted to orientate along a radar direction ray and to measure an absolute radial speed of said vehicle on said roadway with respect to said stationary Doppler radar;
d. a stationary video camera adapted to measure the location of said vehicle on its image plane and said image plane is intersected with said first radar motion ray and said second radar motion ray;
e. a data processing device operatively coupled to said first and second movable Doppler radars, said stationary radar and said stationary video camera, wherein said data processing device comprises a plurality of estimators for Doppler and video signal processing to combine the first relative radial speed, the second relative radial speed, the absolute radial speed and the location of the vehicle to obtain the velocity of the vehicle; and
f. a data recording device operatively coupled to said data processing device to record the processed data.

2. A system of estimating a moving vehicle velocity as recited in claim 1, wherein said first movable Doppler radar and said second movable Doppler radar move with respect to said stationary video camera, and the intersections of said first motion ray and said second motion ray with said image plane are determined by a calibration.

3. A system of estimating a moving vehicle velocity as recited in claim 1, wherein said estimator for stationary Doppler signal processing calculates the absolute speed of said vehicle using said Doppler information from said stationary Doppler radar.

4. A system of estimating a moving vehicle velocity as recited in claim 1, wherein said estimator for movable Doppler signal processing calculates radar-based angle information of said vehicle in the radar geometry using Doppler information from said first movable Doppler radar and said second movable Doppler radar, and said estimator for video signal processing calculates video-based angle information of said vehicle in the video camera geometry using video information from said stationary video camera.

5. A system of estimating a moving vehicle velocity as recited in claim 1, wherein said radar-based angle information of said vehicle is registered to said video-based angle information of said vehicle if the difference of said radar-based angle information and said video-based angle information is smaller than a threshold, and said absolute speed calculated from said stationary Doppler radar is registered to said vehicle on said image plane.

6. A system of estimating a moving vehicle velocity as recited in claim 1, wherein said data recording device records images of said vehicle registered with said speed.
